(19) United States
(12) Patent Application Publication
(10) Pub. No.: US 2006/0218045 A1
(43) Pub. Date: Sep. 28, 2006

(54) PERSONALIZED SEARCH CRITERIA FOR PRODUCING TARGETED QUERY RESULTS

(75) Inventor: Eric J. Wagner, Liverpool, NY (US)

Correspondence Address: BOND, SCHOENECK & KING, PLLC, ONE LINCOLN CENTER, SYRACUSE, NY, 13202-1355, US

(73) Assignee: LOCKHEED MARTIN CORPORATION, Bethesda, MD (US)

(21) Appl. No.: 10/907,251

(22) Filed: Mar. 25, 2005

(51) Int. Cl. G06Q 30/00

(52) U.S. Cl. 705/26

(57) ABSTRACT

The present invention is directed to a method for placing an order for at least one item in a client/server system. The method includes providing a set of human body dimensions related to an apparel item. The step of providing is performed under control of a client computer in response to a user input. Inventory data corresponding to items of apparel available for sale are retrieved under control of a server computer. The inventory data is compared to the set of human body dimensions. The step of comparing is performed under control of the server computer. Only those items of apparel available for sale having an item size corresponding to the set of human body dimensions are selected. The step of selecting is performed under control of the server computer. Data corresponding to the selected items of apparel are displayed under control of the client computer.

### BACKGROUND OF THE INVENTION

The present invention relates generally to electronic commerce, and particularly to a personalized system for shopping over the Internet.

### TECHNICAL BACKGROUND

The Internet developed as a decentralized network for linking universities, government agencies, and other such institutions. In recent years, the Internet has grown into a computer network that interconnects both individual computers and computer networks on a worldwide basis. Thus, the Internet includes millions of interconnected computers. In the developed parts of the world, virtually every business and a vast majority of residences are equipped with computers having Internet access. The fastest growing portion of the Internet is the World Wide Web.

The World Wide Web (WWW) is a system of server computers that is supported and interconnected by the Internet. In the client-server model, web server computers support graphical “web pages” that are provided to “client computers” via the web. The client computer finds the server computer using a browser program. The browser provides a user with an interface that provides the user with an easily understood display, and in turn, converts user input into a web friendly format. When a user indicates that she desires to access to a certain web home page, the browser converts the user input into a Uniform Resource Locator (URL) that uniquely identifies the server. The home page may provide links to documents, services, products, multimedia presentations, news, interactive pages, radio and television broadcasts, and other such information. Much of the information being served to the client is dynamically retrieved by the server from one or more databases.

A relatively new term, “e-commerce,” has been coined to describe the electronic commerce that is now being conducted over the web. Virtually any and every type of transaction may be conducted over the Internet. In fact, it is the exception rather than the rule, for a business not to have a web site for the purpose of advertising and selling its products and services.

Clothing retailers are also trying to exploit the World Wide Web. However, both the retailers and the customers are discovering that clothing retail via e-commerce presents challenges that other retailers are not confronted with. The problem relates to the large variance in sizes from manufacturer to manufacturer. In fact, the variance in clothing sizes has become so large, that the size label disposed on an article of clothing is almost meaningless.

Men's sizes were first standardized during the Civil War era in response to the military's need to get millions of men into uniform as expeditiously as possible. Women's sizes became standardized in the 1940's at the urging of mail-order clothing retailers. In the mean time, both men and women have become taller and heavier. Recently, the American Society for Testing and Materials (ASTM) has attempted to develop industry size standards. The U.S. Army as recently as the late 1980's developed a formula for determining garment specifications based on body measurements. However, none of these standards have been universally adopted by manufacturers. Manufacturers may start with the ASTM standard but usually tweaks the sizes based on their customer research. Adding to this confusion, other manufacturers employ “vanity sizing”—i.e., clothing may be sized to make the customer feel better. It is comforting for a customer to know that she can still fit in a size 12—even if a similarly sized article of clothing is labeled elsewhere as a size 16. Of course, manufacturers do this because they believe that such tactics help them to sell more clothing.

Accordingly, the lack of standard sizes presents a significant drawback when it comes to e-commerce clothing retail. Apparel items are typically organized and presented to the web shopper by category, i.e., as shirts, pants, dresses, and etc. After the consumer finds the category she is looking for, she must then search the category until she finds the item she is looking for. After she finds something that she likes, she must then determine if her size is available. This step is complicated by the fact that, as noted above, one manufacturer's size 12 may be another manufacturer's size 16. Shopping for clothing over the Internet is further complicated for “odd-sized” shoppers, i.e., those who are too short, tall, or heavy.

For example, a search of a well known e-commerce web site yielded the following results: oxford shirts (2178); dress shirts (1006); T-shirts (33,989); turtlenecks (200); work shirts (102); polo shirts (2351); and pull-overs and Henley's (1671). The number in the parentheticals represents the number of items available. However, there is no way of knowing if there is an appropriately sized item. One has to view each of the items one-by-one. However, as noted above, one vendor's size 12 is another vendor's size 16. While the web site will usually provide a size chart for each manufacturer, no one has the patience to sift through 2,178 button-down dress shirts using a different size chart for each vendor to find a shirt they want that is in their size. Often times the consumer will take their best guess that a garment will fit. Unfortunately, there is a good chance that they will end up returning that item. Some merchants compensate by maintaining a large inventory. However, the retailer may struggle to be successful because of the costs associated with merchandise returns and excessive inventory.

What is needed is a “my size” e-commerce shopping system. This system would include a software-based solution that automatically provides a “web shopper” with only those clothing items that are in his/her size.

### SUMMARY OF THE INVENTION

The present invention addresses the needs described above. The present invention is a software solution that allows a web-site shopper to provide the web-site with his or her size measurements.

One aspect of the present invention is directed to a method that includes providing a set of human body dimensions related to an apparel item. The step of providing is performed under control of a client computer in response to a user input. Inventory data corresponding to items of apparel available for sale are retrieved under control of a server computer. The inventory data are compared to the set of human body dimensions. The step of comparing is performed under control of the server computer. Only those items of apparel available for sale having an item size corresponding to the set of human body dimensions are selected. The step of selecting is performed under control of the server computer. Data corresponding to the selected items of apparel are displayed under control of the client computer.

In another aspect, the present invention is directed to a system including a server component that is programmed to receive a set of human body dimensions related to an apparel item. The server component retrieves inventory data in response thereto. The inventory data includes data corresponding to items of apparel available for sale. The server component compares the inventory data to the set of human body dimensions received from the client system. The server component selects only those items of apparel having item size data corresponding to the set of human body dimensions, and transmits an order confirming web page to the client. The order confirming web page includes information corresponding to the selected items of apparel. The system also includes an order processing component coupled to the server component.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block diagram of a client-server system in accordance with an embodiment of the present invention;

FIG. 2A-2C include sizing charts;

FIG. 3 is a flow diagram illustrating a method for accessing the server system in accordance with an embodiment of the present invention;

FIG. 4 is a flow diagram illustrating a method for providing personal data in accordance with an embodiment of the present invention;

FIG. 5 is a diagrammatic depiction of a client record in accordance with an embodiment of the present invention;

FIG. 6 is a flow diagram illustrating a method for placing an order in accordance with an embodiment of the present invention;

FIG. 7 is a flow diagram illustrating a method for placing an order in accordance with yet another embodiment of the present invention;

FIG. 8 is a flow diagram illustrating a method for advertising in accordance with an embodiment of the present invention; and

FIG. 9 is a flow diagram illustrating a method for managing inventory in accordance with the present invention.

### DETAILED DESCRIPTION

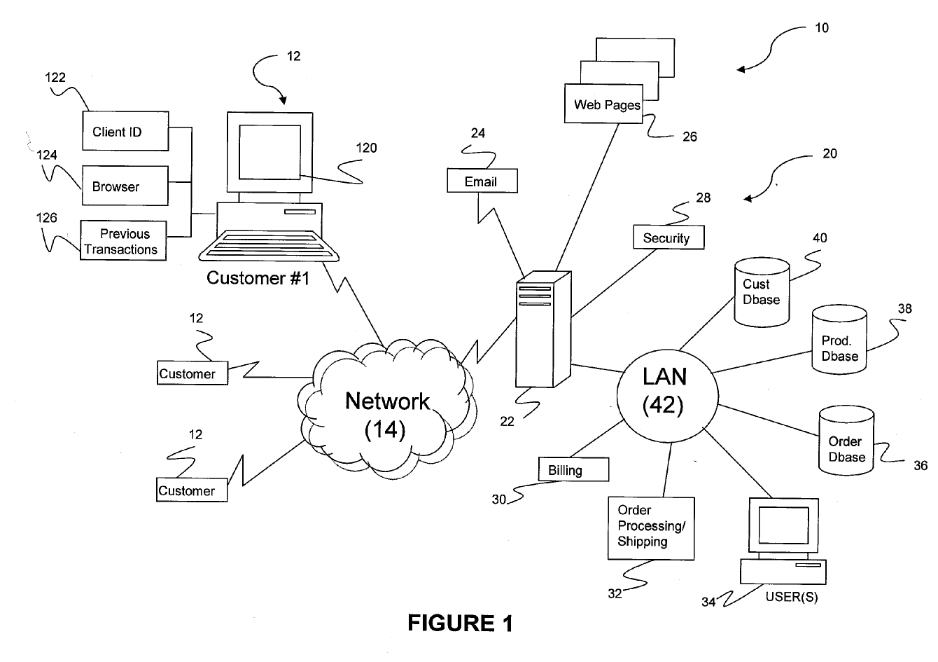

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the client-server system of the present invention is shown in FIG. 1, and is designated generally throughout by reference numeral 10.

As embodied herein, and depicted in FIG. 1, a block diagram of a system 10 for conducting electronic commerce in accordance with one embodiment of the present invention is disclosed. System 10 includes client systems 12 coupled to server system 20 by way of network 14. Client system 12 typically includes a computer 120 which may access network 14 by a dial-up service, DSL, or a high speed connection. Computer 120 may be a stand-alone computer or disposed in a local area network (LAN) or a wide area network (WAN). A client identifier 122, a browser program, and a record of previous transactions with server system 20 may reside on computer 120. Server system 20 includes a server computer 22. Server computer 20 may be implemented as a stand-alone computer system, or may optionally be part of a local area network 42. Network 14 may be the packet switched network commonly referred to as the Internet.

As those of ordinary skill in the art will appreciate, server computer 22 may typically include computer hardware, an operating system, web server software, and information content, such as web pages 26. Server computer 22 also may include email server 24 capability, as well as security software 28. In the embodiment depicted in FIG. 1, server computer 22 is also coupled to a customer database 40, a product inventory database 38, an order database 36, local user computers 34, order processing software 32, and billing software 30 by way of LAN 42. Those skilled in the art will recognize that LAN 42 and the other software components listed above may reside on server 22. A more detailed description of the hardware and software that may be used to implement the present invention follows.

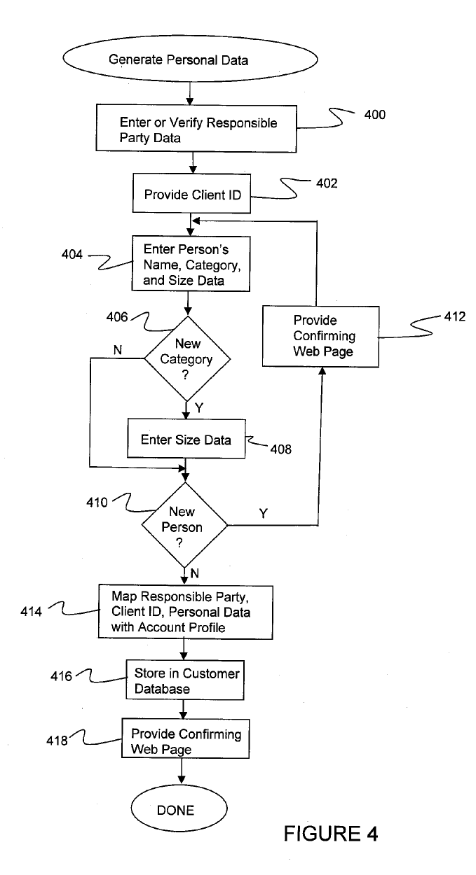

The computer systems used to implement the present invention include a processor (CPU) coupled to an internal bus. System memory typically includes random access memory (RAM), or some other dynamic storage device, coupled to the processor by way of the bus. RAM is employed to store the data and instructions that are executed by the processor. RAM may also be used to store temporary variables or other intermediate information during execution of instructions by the processor. The computer systems further include read only memory (ROM) or other such static storage device. ROM (EPROM, E²PROM, and etc.) are coupled to the bus and are used to store static information and instructions for the processor. The processes of the present invention described herein (FIGS. 4-9) are performed by the computer systems in response to the execution of the instructions contained in RAM. These instructions are written into RAM from the ROM, or some other computer-readable medium. The execution of the arrangement of instructions contained in RAM directs the CPU to perform the process steps described herein. Server system 22 may employ more than one processor, in a multi-processing arrangement, to execute the instructions contained in system RAM.

The computer systems used to implement the present invention may be equipped with at least one communication interface. The communication interfaces provide a two-way data communication path between the system and any of the networks used to carry the information content. It will be apparent to those of ordinary skill in the pertinent art that modifications and variations may be made to the communications interface depending on the nature and sophistication of the client system, and also on the server computer's network environment. For example, the communication interface may support a digital subscriber line (DSL) card or modem, an integrated services digital network (ISDN) card, a cable modem, a telephone modem, or any other communication interface to provide a data communication connection to a corresponding type of communication line. The communication interface may also include a local area network (LAN) card (i.e., Ethernet™ or Asynchronous Transfer Model (ATM) network). Wireless links may also be implemented. In any of the above listed implementations, communication interface may transmit and receive electrical, electromagnetic, or optical signals that carry digital data streams representing various types of information. Further, the communication interface may include peripheral interface devices, such as a Universal Serial Bus (USB) interface, a PCMCIA (Personal Computer Memory Card International Association) interface, etc. Of course, the computer systems used to implement the present invention may employ multiple communication interfaces.

The term “computer-readable medium” as used herein refers to any medium that participates in providing instructions to the processor for execution. Such a medium may take many forms, including but not limited to non-volatile media, volatile media, and transmission media. Non-volatile media include dynamic memory, such as main memory. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Transmission media include coaxial cables, copper wire and fiber optics, including the wires or traces that comprise the bus. Transmission media may also take the form of acoustic, optical, or electromagnetic waves, such as those generated during radio frequency (RF) and infrared (IR) data communications.

With regard to the software elements of the present invention, the operating system (OS) employed by system 20 may be of any suitable type, such as those provided by Windows, UNIX, Linux, Apache, and/or etc. As those skilled in the art will appreciate, the OS manages the hardware and software resources of the system. CPU resources, memory and storage allocation, and I/O resources must be efficiently managed.

The web server software waits for requests from the client computers 120. Once a request is received, the request is parsed, classified, and an action is taken. Server 22 is configured to dynamically execute programs to provide interactive web pages. This type of functionality allows server 22 to provide electronic fill-in forms and similar features that are essential to conducting e-commerce. It will be apparent to those of ordinary skill in the pertinent art that modifications and variations can be made to the web server software of the present invention depending on cost and functionality. The web server software may be implemented using Java Web Server software, Apache Web Server software, Microsoft Personal Web Server software, Microsoft Frontpage Web Server software, and Microsoft Internet Information Server software.

In general, server system 20 serves the information content to clients 12 by providing web pages, which are typically hypertext documents. HTML is typically the coding language used to create hypertext documents for use on the web. HTML uses certain symbols and codes that are used by the client web browser 124 to correctly display a web page's words and images for the user. The web pages may be transmitted from the server computer 22 to the client systems 12 by way of the Hypertext Transfer Protocol (HTTP). In particular, server system 20 provides client systems 12 with a means for ordering apparel on-line. The user provides a set of human body dimensions related to an apparel item. The dimensions are provided to server 22 by the client computer 12. Server computer 22 retrieves inventory data in response thereto. The inventory data includes size data for each of the items of apparel available for sale on the web site. The server compares each item's size data to the set of human body dimensions. The server selects an item of apparel when the size data corresponds to the set of human body dimensions. The server transmits a web page to the client system 12. The web page includes information corresponding to the items of apparel selected by server 22 based on the size comparison. Client computer 120 displays the web page to the user.

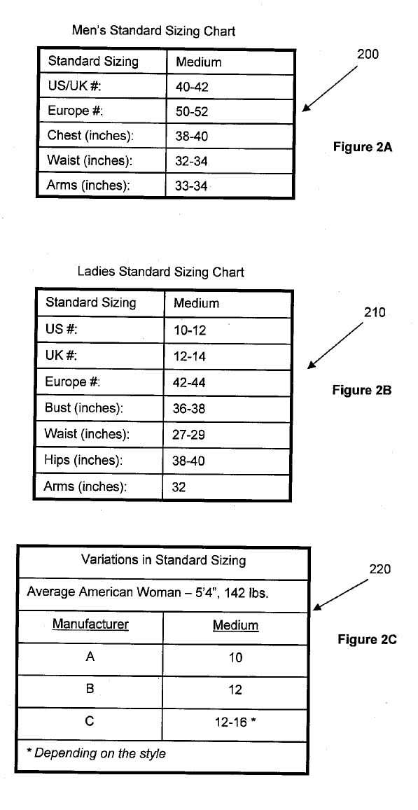

Referring to FIGS. 2A-2C, examples of sizing charts are provided to illustrate the drawbacks associated with purchasing clothing and other apparel items using current state of the art e-commerce systems. FIG. 2A shows the standard sizing chart for a men's medium size. For men, both the U.S. and U.K. standard medium shirt size are considered as size 40-42. However, the same measurements may also be considered a size 50-52 if the European standard shirt size is used. FIG. 2B illustrates the standard sizes associated with a women's medium shirt size. The standard U.S. women's medium size shirt is considered a size 10-12. In the U.K., the same size blouse is considered a size 12-14. The Europeans provide yet another standard size. The Europeans consider the blouse a size 42-44. The size issue becomes further complicated when one considers that manufacturers rarely use the standard sizes.

For example, FIG. 2C provides the medium pants sizes for three well known clothing manufacturers. Research reveals that the “average American women,” i.e., a medium sized American woman, is 5′-4″ tall, and weighs 142 lbs. However, manufacturer “A” provides size 10 pants for a medium sized woman. Manufacturer B labels the same size pants as a size 12. Manufacturer C may label the pants as being a size 12, 14, or 16, depending on the style. If a consumer orders a size 10 from manufacturer “C”, the garment will not fit the medium sized American woman. If she orders a size 10 from manufacturer “A”, on the other hand, it will.

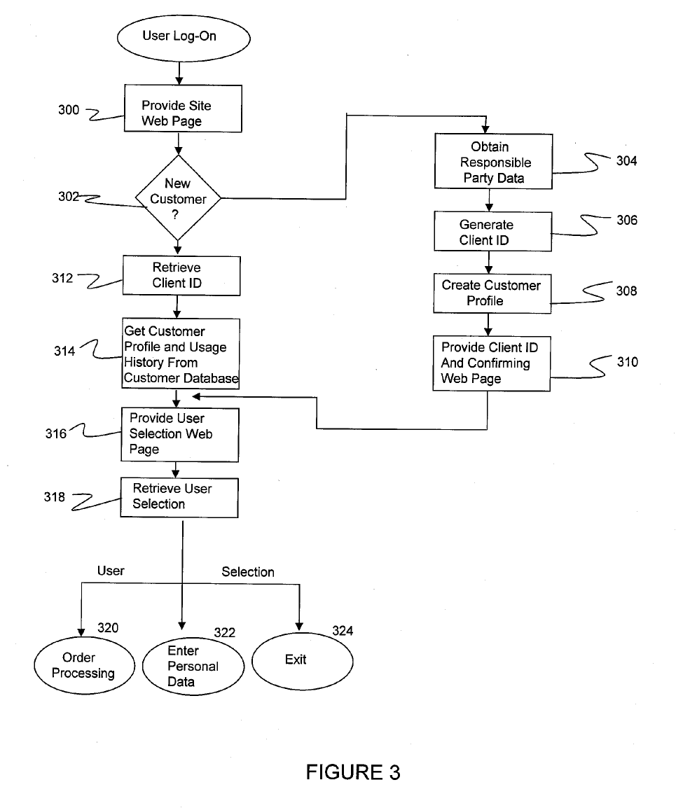

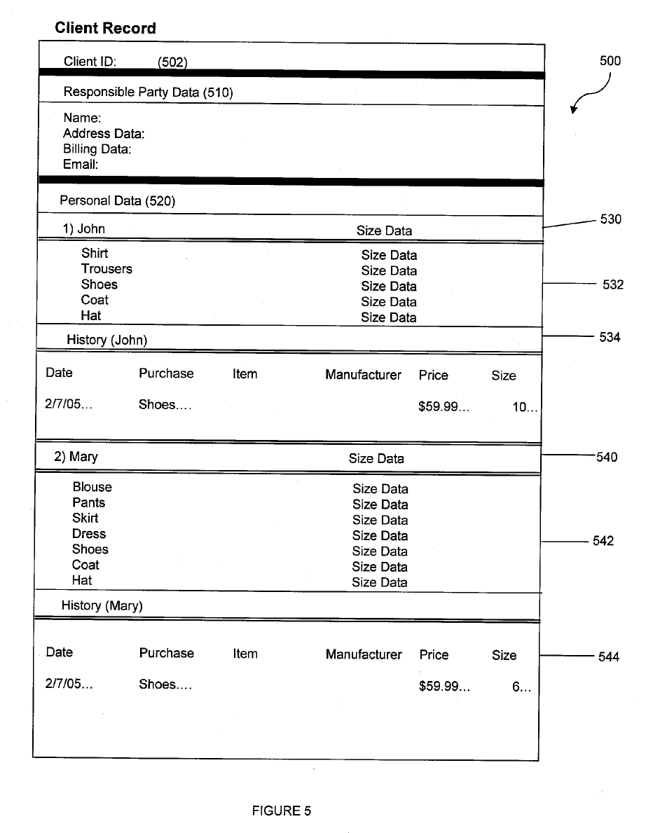

As embodied herein and depicted in FIG. 3, a flow diagram illustrating a method for accessing the server system in accordance with one embodiment of the present invention. A user initially requests access to the web site using browser 124 on client computer 120. The server computer 22 provides client 12 with the site web page, and the client computer 120 displays the web page for the user. The user may be a new customer, or may be a return customer that has a client record (See FIG. 5) stored in customer database 40. If the user is a new customer, server 22 provides an interactive web page that allows the user to enter his “responsible party data,” i.e., his name, billing data, shipping address, and other such data. The billing data may include the user's VISA or Master card information, or other such means of payment that are currently employed. In step 306 and 308, the server provides the new user with a client identifier, establishes a customer profile based on the information provided by the user, and stores this information in a newly created client record, which may be accessed by the client identifier, client name, social security number, or by some other secure method. One this is accomplished, server 22 provides client 12 with a confirming web page.

If the user is an established customer, the user enters his client identifier using a web page provided by server 22. Once this data is input, server 22 retrieves the client identifier in step 412. Server 22 uses the client identifier to obtain the client record which includes the customer's profile, usage history, and other such data. In step 416, server 22 transmits a user selection web page to client 12. The user selection web page is displayed, and the user may make a selection, provide more personal data, or he may decide not to make a selection and exit the web site. If the user makes a selection, server 22 processes the user's order in step 320. If the user decides to provide additional data, such as add a new person to the profile, that person's individual human body dimensions for a given item of apparel (i.e., shirt, pants, coat, etc.) are provided to the server 22. Note that the present invention allows the responsible party to shop on-line for more than one person. Further, the system will store a personal profile for each person.

Referring to FIG. 4, a flow diagram illustrating a method for providing personal data in accordance with one embodiment of the present invention is disclosed. Initially, the user provides the responsible party data and the client identifier. In step 404 the person's name, item category, and the human body dimensions for that category are entered under the control of the client computer 12. For example, if the user is shopping for a shirt for “Timmy,” the user selects the “shirt” category and provides Timmy's name, and his chest, waist, and arm measurements. In steps 406, 408, the user may provide Timmy's personal human body dimensions for other apparel categories. The user may desire to enter additional person's to his account profile. After this information is provided to server 22, server 22 builds the client record and stores the record in customer database 40. In step 518, server 22 transmits a confirming web page to client system 12.

FIG. 5 is a diagram of a client record in accordance with an embodiment of the present invention. Client record 500 includes a client identifier field 502. The identifier may be an alphanumeric identifier, or may be implemented using a log-in identifier and a password. Either way, the client identifier uniquely identifies the responsible party. Responsible party information is provided in field 510. Responsible party data may include a responsible party name, a mailing address, billing information, and an email address. Client record 500 also includes a personal data field 520. As noted above, the personal data section 520 may include profiles for one or more persons. In the example provided in FIG. 5, a personal profile 530, 540 are provided for “John” and “Mary,” respectively. The first field (532, 542) provides human body dimensions for each apparel item category. The second field 534, 544, provides a customer usage profile for each person. Note that the server 22 may sort the information in the columns to obtain any statistical measure desired. As shown in FIG. 5, the personal profile field records the data an item was purchased, a description of the item, the item's price, the manufacturer/vendor, and the item's size. Those skilled in the art will understand that any number of informational categories may be included in field.

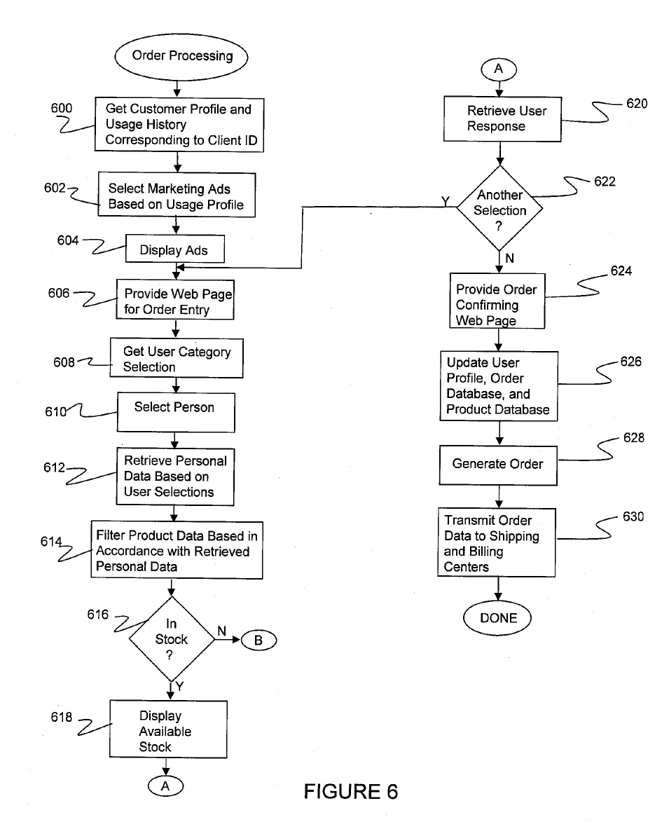

As embodied herein and depicted in FIG. 6, a flow diagram illustrating a method for placing an order in accordance with the present invention is disclosed. Once the user is in the web site and server 22 has verified the client identifier, server 22 retrieves the corresponding customer profile from the customer database 40. In optional step 602, server 22 may be programmed to compare the customer profile with advertisements, special offers, and sales information to determine if any of this information is relevant to the user. As an alternative, server 22 may automatically retrieve all of the advertisements from product/inventory database 38. Either way, a marketing data web page having this data may be provided to client 12 and subsequently displayed to the user. Of course, those skilled in the art will recognize that steps 602 and 604 may be eliminated altogether. Instead, the user selection web page (FIG. 3) may be interactive and include a selection icon that leads the user to the advertisements, special offers, and sales information.

In step 606, an interactive user selection web page is provided by server 22 to client 12. In step 608, the user selects an apparel item category, such as shirts, pants, and etc. Subsequently, the user identifies the person she is shopping for in step 610. In response, server 22 retrieves the client's record, looks for the identified person, and obtains the person's human body dimensions for the selected category of apparel. In step 614, server 22 sorts/filters the product database using the person's human body dimensions. If the person is a male and the user is attempting to buy an oxford/button-down shirt for the person, server 22 will only look for the category of men's button down shirts. The next step in the filtering process is directed to filtering category inventory items by size.

As noted in the discussion of FIGS. 2A-2C, each manufacturer may employ a different size chart. Accordingly, the category inventory may be sub-divided by manufacturer and/or model/style to thereby group category items by size chart. In one embodiment, server 22 may employ a look-up table that provides a range of human body dimensions for each size in each size chart. The server compares the person's human body dimensions with the range of human body dimensions for each size in the look-up table to determine which size will fit the person. In the next step 616, the server computer 22 compares the sub-group inventory to determine if an appropriately sized item is in stock. If not, a back order is generated. This process is repeated until every sub-category has been sorted and filtered. The filtering process provides a list of items that are virtually certain to fit the selected person. Those skilled in the art will understand that any suitable method for filtering/sorting the selected category may be employed by the present invention.

In step 618, the server 22 is provides client 12 with a web page for displaying the available stock in the person's size. The web page is transmitted to the client 12 and displayed to the user. The web page provides is interactive in that it allows the user to select one or more of the items being displayed. In step 620, the user reviews the filtered inventory and makes a selection. The order selection web page may provide a photographic representation of each of the items available. The item selection process may employ the “shopping cart” model or any suitable means known in the art. In step 622, the user may repeat the process and order additional items for the same person or for other persons. Once the selection process has been completed, server 22 provides client 12 with an order confirming web page. Finally, in steps 628 and 630, server 22 transmits the order to billing 30 and order processing 32 (see FIG. 1).

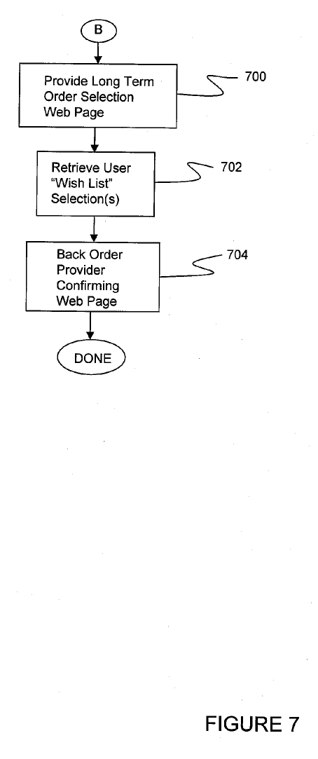

FIG. 7 is a flow diagram illustrating a method for placing back orders in accordance with the present invention. As noted above in the discussion of FIG. 6, if the filtering process reveals that there are no items available in a person's size, server 22 provides client 12 with a long term order selection page. The web page asks the user if she desires to back order the item that was not available in the person's size. The web page may also give the user an opportunity to back order other items as well. Once this process is completed, server 22 provides client 12 with a web page that confirms the back order.

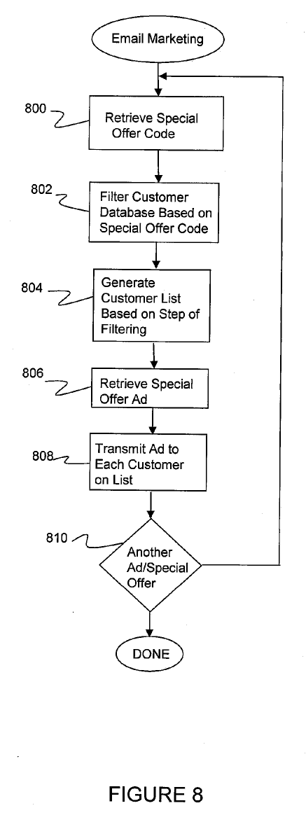

Referring to FIG. 8, a flow diagram illustrating a method for advertising in accordance with the present invention is disclosed. In step 800, server 22 retrieves a special offer code. The special offer code may be input by one of the user computers 34 shown in FIG. 1. The special offer code may be targeted to a single category of items that are being placed on-sale, or perhaps, a new product that is being offered by one of the manufacturers carried by the web site. In step 802, server 22 filters the customer database to identify those persons who may be interested in the special offer. Interest is gauged by reviewing a person's purchasing history (See FIG. 5), or by determining whether a person has human body size dimensions for the item on sale. In step 804, server 22 generates a list of customers in accordance with the filtering process. In step 806, server 22 retrieves the ads corresponding to the customer list and employs the email server 24 to transmit the ads via email. In an alternate embodiment, the ads may be sent to the appropriate customer by way of regular mail using the responsible party address data. In light of the fact that there may be more than one item on sale at any given time, server 22 may repeat the process until all of the special offer ads are processed and disseminated.

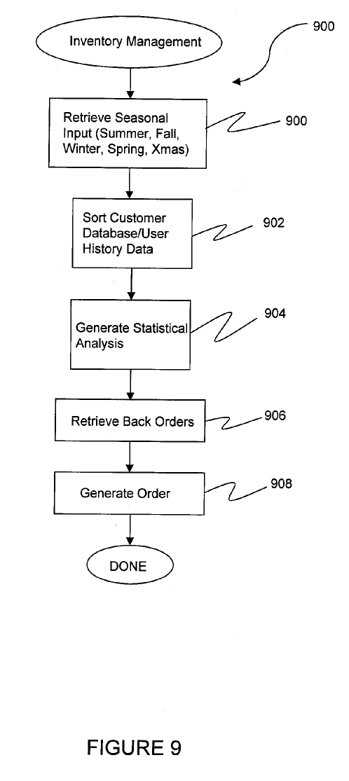

Referring to FIG. 9, a flow diagram illustrating a method for managing inventory in accordance with the present invention is disclosed. As noted in the Background Section, e-commerce merchants may not be as profitable as they could be because of the costs associated with returned merchandise and maintaining a large inventory. Accordingly, it is imperative for e-commerce retailers to efficiently manage their inventories.

Referring to step 900, when an apparel retailer orders clothing, whether e-commerce related or not, it must take into account the season. In step 902, server 22 sorts the customer database to obtain statistical data. The usage history is of particular interest for obvious reasons. Depending on how complicated the analysis is, one can calculate the number of items sold for each category of apparel. The present invention allows the server 22 to further break this down by size, manufacturer, cost, date, and etc. By combining this information with back order data, server 22 may accurately predict the demand for every item. Thus, the purchase order generated in step 908 requests items by vendor, apparel type, style, and size in accordance with the analysis performed in step 904.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method comprising:
providing a set of human body dimensions related to an apparel item, the step of providing being performed under control of a client computer in response to a user input;
retrieving inventory data corresponding to items of apparel available for sale under control of a server computer;
comparing the inventory data to the set of human body dimensions, the step of comparing being performed under control of the server computer;
selecting only those items of apparel available for sale having an item size corresponding to the set of human body dimensions, the step of selecting being performed under control of the server computer; and
displaying data corresponding to the selected items of apparel, the step of displaying being performed under control of the client computer.

2. The method of claim 1, further comprising the step of converting the item size into a range of human body dimensions.

3. The method of claim 1, wherein the item size includes a standard size designation.

4. The method of claim 3, further comprising:
converting the standard size designation into a range of human body dimensions; and
determining whether the set of human body dimensions is in the range of human body dimensions.

5. The method of claim 1, wherein the item size includes a manufacturer's size designation.

6. The method of claim 5, further comprising:
converting the manufacturer's size designation into a range of human body dimensions; and
determining whether the set of human body dimensions is in the range of human body dimensions.

7. The method of claim 1, further comprising:
transmitting a web page to the client computer, the web page including web site entry means;
displaying the web page under control of the client computer;
transmitting a client identifier to the server computer by way of the web site entry means, the step of transmitting being performed in response to a user input; and
retrieving a customer profile record corresponding to the client identifier under control of the server computer, the customer profile record including responsible party data and at least one set of personal data.

8. The method of claim 7, wherein the responsible party data includes a responsible party name, responsible party billing information, responsible party address data, and a responsible party email address.

9. The method of claim 7, wherein the at least one set of personal data includes a person's name, the person's purchasing history, and a set of the person's human body dimensions for at least one type of apparel item.

10. The method of claim 9, wherein the at least one set of personal data includes a set of personal data for a plurality of persons.

11. The method of claim 9, wherein the at least one type of apparel item is selected from a group of apparel items that includes shirts, blouses, pants, trousers, skirts, dresses, coats, sweaters, hats, shoes, ties, and/or jewelry.

12. The method of claim 7, wherein the customer profile record is retrieved from a customer database having stored therein a plurality of customer profile records.

13. The method of claim 1, further comprising:
providing the client computer with a web page, the web page including web site entry means for initial users;
displaying the web page under control of the client computer;
transmitting user data from the client computer to the server computer by way of the web site entry means for initial users, the step of transmitting being performed in response to a user input;
transmitting a client identifier to the client computer in response to receiving the user data; and
creating a customer profile record that relates the user data to the client identifier under control of the server computer, the customer profile record including responsible party data and at least one set of personal data.

14. The method of claim 13, wherein the responsible party data further comprises a responsible party name, responsible party billing data, and a responsible party address.

15. The method of claim 13, wherein the at least one set of personal data includes a person's name, the person's purchasing history, and a set of the person's human body dimensions for at least one type of apparel item.

16. The method of claim 15, wherein the at least one set of personal data includes a set of personal data for a plurality of persons.

17. The method of claim 1, further comprising:
transmitting a user selection web page from the server computer to the client computer, the user selection web page providing a plurality of apparel item categories;
displaying the user selection web page under control of the client computer; and
selecting an apparel item category from the plurality of apparel item categories under control of the client computer.

18. The method of claim 17, wherein the step of retrieving includes selecting only those items of apparel corresponding to the selected apparel item category.

19. The method of claim 17, wherein the step of providing includes transmitting the selected apparel item category and the set of human body dimensions to the server computer in response to a user input.

20. The method of claim 1, wherein the inventory data for each item of apparel includes a record having a category identifier, an item description, and item size data.

21. The method of claim 1, further comprising:
providing advertisement information under control of the server computer;
retrieving customer profile records under control of the server computer, each customer profile record including responsible party data and at least one set of personal data, the at least one set of personal data including a usage history and the set of human body dimensions;
comparing the advertisement information to the customer profile records;
selecting those customer profile records that have a usage history and a set of human body dimensions corresponding to the advertisement information; and
transmitting the advertisement information to every responsible party identified in the selected customer profile records under control of the server computer.

22. The method of claim 21, wherein the step of transmitting is performed by sending an email message to the responsible party.

23. The method of claim 21, wherein the step of transmitting is performed by mailing the advertisement information to a responsible party address.

24. The method of claim 1, wherein a back order is generated in response to no apparel item records being selected in the step of selecting.

25. The method of claim 1, further comprising:
analyzing a customer database to determine aggregate purchasing patterns over a predetermined period of time; and
maintaining a product inventory based on the step of analyzing.

26. A system comprising:
a server component programmed to,
receive a set of human body dimensions related to an apparel item from a client system,
retrieve inventory data in response to the client system transmission, the inventory data including data corresponding to items of apparel available for sale,
compare the inventory data to the set of human body dimensions received from the client system,
select only those items of apparel having item size data corresponding to the set of human body dimensions, and
transmit an order confirming web page to the client, the order confirming web page including information corresponding to the selected items of apparel; and
an order processing component coupled to the server component.

27. The system of claim 26, wherein the client system is configured to display the order confirming web page.

28. The system of claim 26, wherein the server computer is configured to convert the item size data into a range of human body dimensions.

29. The system of claim 26, wherein the item size data includes a standard size designation.

30. The system of claim 29, wherein the server computer is further programmed to:
convert the standard size designation into a range of human body dimensions;
determine whether the set of human body dimensions is in the range of human body dimensions; and
select only those apparel item records having a range of human body dimensions that includes the set of human body dimensions.

31. The system of claim 26, wherein the item size data includes a manufacturer's size designation.

32. The system of claim 31, wherein the server computer is further programmed to:
convert the manufacturer's size designation into a range of human body dimensions;
determine whether the set of human body dimensions is in the range of human body dimensions; and
select only those apparel item records having a range of human body dimensions that includes the set of human body dimensions.

33. The system of claim 26, further comprising a customer database coupled to the server system, the customer database being disposed on a computer readable medium having stored thereon a plurality of customer profile records, each customer profile record comprising:
a client identifier field including client identification data;
a responsible party data portion; and
a personal data portion.

34. The system of claim 33, wherein the responsible party data portion relates a responsible party name field, responsible party address data field, responsible party billing data field, and a responsible party email address field.

35. The system of claim 33, wherein the personal data portion includes at least one personal data set, the at least one personal data set relating a name, a personal usage history portion and a personal size information portion.

36. The system of claim 35, wherein the personal size information field includes at least one personal apparel item size entry field having an apparel item identifier and a corresponding set of human body dimensions.

37. The system of claim 36, wherein the at least one apparel item identifier is selected from a group of apparel items that include shirts, blouses, pants, trousers, skirts, dresses, coats, sweaters, hats, shoes, ties, and/or jewelry.

38. The system of claim 35, wherein the personal size information field includes a plurality of personal apparel item size entries.

39. The system of claim 35, wherein the at least one personal data set includes a plurality of personal data sets.

40. The system of claim 35, wherein the personal usage history portion includes at least one personal usage entry field that relates a purchase date, a purchase description, a purchase price field, and a purchase size field.

41. The system of claim 26, further comprising a product inventory database that relates a product description information, product pricing information, product manufacturer information, product size information, and available quantity information.

42. The system of claim 41, wherein the product inventory database includes manufacturer size chart conversion data.
